(19) United States
(12) Patent Application Publication
(10) Pub. No.: US 2008/0127062 A1
(43) Pub. Date: May 29, 2008

(54) METHOD AND COMPUTER READABLE MEDIUM STORING INSTRUCTIONS FOR CREATING OPEN VECTOR GRAPHIC CONTENTS

(75) Inventor: Young Ouk Kim, Gunpo-si (KR)

Correspondence Address: FOLEY AND LARDNER LLP;SUITE 500, 3000 K STREET NW, WASHINGTON, DC, 20007, US

(73) Assignee: CORE LOGIC INC.

(21) Appl. No.: 11/843,478

(22) Filed: Aug. 22, 2007

(30) Foreign Application Priority Data
Nov. 29, 2006 (KR) 10-2006-0118990

(51) Int. Cl. G06F 9/44; G06F 12/16

(52) U.S. Cl. 717/106; 707/204; 707/E17.01

(57) ABSTRACT

Provided are a method for creating Open Vector Graphic (OpenVG) contents and a computer readable record medium storing instructions for executing a method for creating OpenVG contents. The method comprises providing an environment in which contents are written; creating an OpenVG Application Program Interface (API) syntax associated with the written contents; driving and checking the created OpenVG API syntax; creating a final OpenVG API script made up of the OpenVG API syntax; and storing contents objectified by the final OpenVG API script.

### RELATED APPLICATIONS

This nonprovisional application claims priority under 35 U.S.C. § 119(a) to Korean Patent Application No. 10-2006-0118990, filed Nov. 29, 2006, the entire contents of which are hereby incorporated by reference.

### BACKGROUND OF THE INVENTION

1. Field of the Invention

The present invention relates to open vector graphic contents, and more particularly, to a method for creating Open Vector Graphic (OpenVG) contents and a computer readable record medium storing instructions for executing the method.

2. Description of the Related Art

Vector graphic is the digital image created by a series of commands or mathematical statements that place lines or shapes in a given two-dimensional or three-dimensional space. In physics, a vector is a representation of both a quantity and a direction at the same time. In vector graphics, a graphic file that results from a graphic artist's work is created and saved as a sequence of vector statements. For example, to draw a line, a vector graphic file contains the information of the points to be connected instead of information of each point on the line. This results in the file size being much smaller. The vector graphic file is easier to modify than a raster image file.

As one kind of the vector graphics, there is Scalable Vector Graphics (SVG) which describes images based on the extensible markup language (XML). SVG is widely used in the Web and is abundant in contents. However, SVG is slow in speed under a mobile environment and thus reduces in utilization because it processes many driving functions by using software.

Thus, in recent years, OpenVG is being used as mobile vector graphics for creating contents to be served for a mobile terminal. OpenVG led to improvement on a low rate under the mobile environment because it provides APIs which are supporting hardware acceleration to a variety of mobile terminals.

Previously, a contents developer would spend much time and make unnecessary efforts to repeat the same or similar work to obtain the contents achievable by Open VG.

### SUMMARY OF THE INVENTION

Accordingly, the present invention provides an OpenVG contents creation method for conveniently and easily creating contents served for a mobile terminal.

Also, the present invention provides an OpenVG contents creation method for creating contents rapidly in an OpenVG format at high efficiency and high quality.

Also, the present invention provides a computer readable record medium for storing instructions for executing a method for creating OpenVG contents.

In one aspect, there is provided a method for creating OpenVG contents. The method comprises providing an environment in which contents are written; creating an OpenVG API syntax associated with written contents; driving and checking the created OpenVG API syntax; creating a final OpenVG API script made up of the OpenVG API syntax; and storing contents objectified by the final OpenVG API script.

The contents may comprise mobile contents served for a mobile terminal.

The providing of the environment may comprise selecting an object of contents to be written, depending on information inputted by user; displaying the selected object of the contents on a writing screen; and registering and editing an attribute or event of the displayed object of the contents depending on information inputted by user.

The providing of the environment may comprise providing an image converted into an OpenVG format as an object of the contents to the environment in which the contents are written.

The providing the converted image may comprise reading a previously created image file; separating a header from a body in the image file; selecting any one of the OpenVG formats depending on information inputted by user; converting a format of the image file into the selected OpenVG format; and providing the converted image file to the environment in which contents are written.

The providing the converted image may further comprise checking whether the converted image is suitable as the OpenVG API syntax.

The creating of the OpenVG API syntax may comprise registering and extracting a syntax associated with an attribute or event of an object of the written contents; creating an OpenVG format syntax for each of the registered syntax; checking a format of the created OpenVG format syntax; and creating an OpenVG API syntax format of the written contents.

The method may further comprise displaying the written contents or the driven syntax.

The storing objectified contents may comprise storing an inherent value associated with an attribute or an event of an object of the contents as a file.

The storing objectified contents may comprise creating a header of the object of the contents; deciding a memory size for storing the object of the contents; structuralizing an attribute or event in a file form and adding the attribute or event to the object of the contents; giving the inherent value to the addition-completed object of the contents; and storing the object of the contents as a file.

The method may further comprise providing the stored contents to the environment in which contents are written.

A computer readable record medium stores instructions for executing the method for creating OpenVG contents.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 is a flowchart illustrating a method for creating OpenVG contents according to an exemplary embodiment of the present invention;

FIG. 2 is a flowchart illustrating a method for writing contents according to an exemplary embodiment of the present invention;

FIGS. 3 to 5 illustrate a computer screen on which each step of FIG. 2 is realized;

FIG. 6 is a flowchart illustrating a method for creating an OpenVG API syntax according to an exemplary embodiment of the present invention;

FIG. 7 illustrates a method for driving and checking syntax according to an exemplary embodiment of the present invention;

FIG. 8 is a flowchart illustrating a method for storing contents according to an exemplary embodiment of the present invention;

FIG. 9 illustrates the layout of a contents file according to an exemplary embodiment of the present invention; and

FIG. 10 is a flowchart illustrating a method for converting image according to an exemplary embodiment of the present invention.

### DETAILED DESCRIPTION OF PREFERRED EMBODIMENTS

Preferred embodiments of the present invention will be described in a more detailed manner with reference to the drawings.

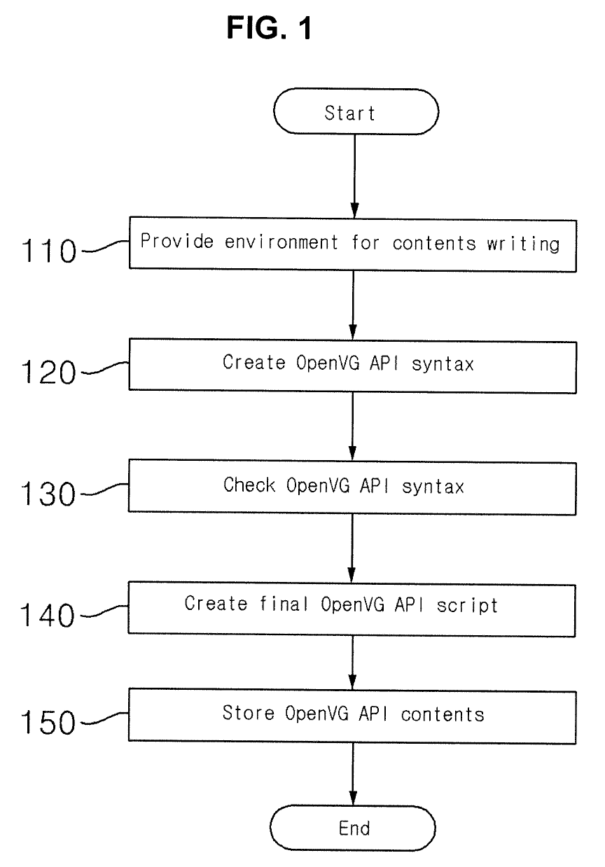

FIG. 1 is a flowchart illustrating a method for creating OpenVG contents according to an exemplary embodiment of the present invention. As shown in FIG. 1, the method for creating the OpenVG contents according to an exemplary embodiment of the present invention comprises the following steps.

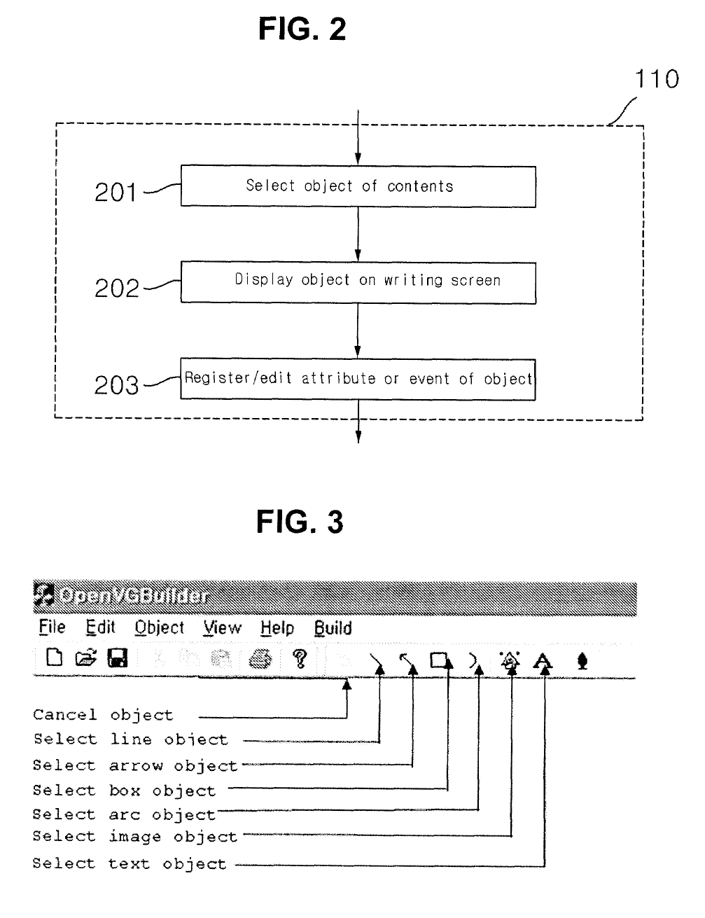

According to an exemplary embodiment of the present invention, in Step 110, a user (e.g., a contents developer) is provided with an environment in which contents can be written. The writing environment can be realized on a Web-based client or a computer. Under the writing environment, contents are written depending on information inputted by the user. A detailed description of the Step 110 will be later made with reference to FIGS. 2 to 5.

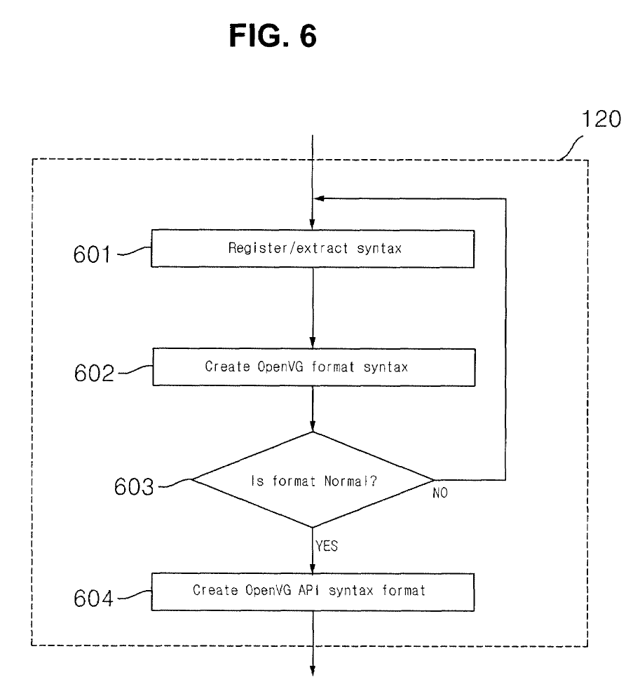

In Step 120, an OpenVG API format syntax associated with the written contents is created. The OpenVG format syntax is created in real time along with writing contents. The created OpenVG syntax is checked and then, an OpenVG API syntax format is completed. This will be later described in more detail with reference to FIG. 6.

In Step 130, the created OpenVG API syntax is driven and checked. The created OpenVG API syntax is driven and displayed so that the user can recognize and check the created OpenVG API syntax. By previously driving the OpenVG API syntax as above, user can previously check a normality of the OpenVG API syntax and a degree of his/her satisfaction with writing, thereby modifying and editing the OpenVG API syntax.

In Step 140, a final OpenVG API script made up of the OpenVG API syntax is created. The Step 140 is to combine the created and checked OpenVG API syntax associated with an attribute or event of an object of contents and create one final OpenVG API script.

In Step 150, contents objectified by the final OpenVG API script are stored. Driven contents are objectified by the final OpenVG API script and are stored in a file form. Thus, the stored contents file can be reused when contents are edited or other contents are written in the future. The contents, which are mobile contents served for a mobile terminal, can be driven at a high rate through hardware acceleration in a mobile terminal supporting OpenVG.

As described above, in an exemplary embodiment of the present invention, contents can be automatically created in conformity to an OpenVG format, which is one of high-quality vector graphic formats for a mobile terminal. In other words, the user can arbitrarily write contents using a writing environment, and the written contents automatically create and derive an OpenVG format API script, thereby increasing the efficiency of writing contents compared to the case OpenVG contents were manually developed and written. Also, the automatically created OpenVG API syntax can be displayed, thereby enabling real-time checking. Thus, high-quality OpenVG format contents can be created within a short time.

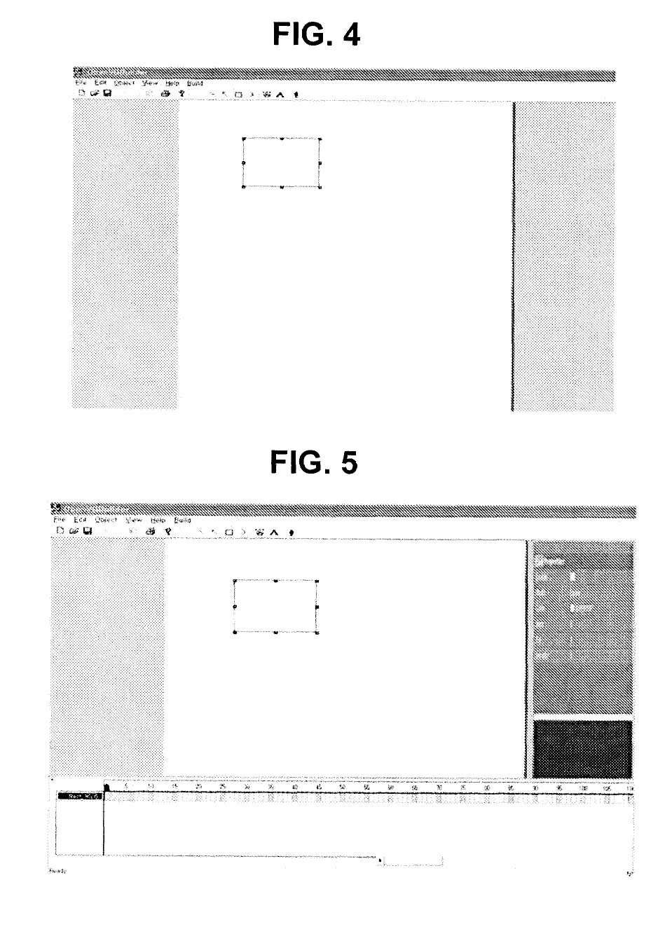

FIGS. 2 to 5 illustrate a method for writing contents according to an exemplary embodiment of the present invention. FIG. 2 is a flowchart illustrating the method for writing contents according to an exemplary embodiment of the present invention. FIGS. 3 to 5 illustrate a computer screen on which each step of FIG. 2 is realized.

Referring to FIGS. 2 and 3, in Step 201, an object of contents to be written is selected depending on information inputted by the user. As shown in FIG. 3, the object is a line, an arrow, a box, an arc, an image, a text, etc. An object to be intended for writing is selected by the user from the objects.

Referring to FIGS. 2 and 4, in Step 202, the selected object of the contents is displayed on a writing screen. The writing screen is a screen that is provided to the user in real time for a convenience of contents writing. The writing screen displays written contents, a contents writing tool, and a contents writing procedure depending on information inputted by the user. The selected object of the contents can be disposed in any position of the writing screen. For example, a box object is selected, disposed, and displayed on the writing screen as shown in FIG. 4.

Referring to FIGS. 2 and 5, in Step 203, an attribute or event of the displayed object of the contents is registered or edited depending on information inputted by user. For example, as shown in FIG. 5, user registers and edits the attribute or event of the object of the contents and completes the contents writing, using an attribute window and a time slice event window. The attribute window is positioned at a right side of the writing screen and the time slice event window is positioned at a lower side of the writing screen.

As above, the user can select each object (e.g., a line, a surface, a circle, an oval, a box, a cube, an image, etc.) available for OpenVG format in the provided writing environment, freely dispose the selected object on the writing screen, and register and edit the attribute and event of the object of the contents, thereby writing contents without difficulty.

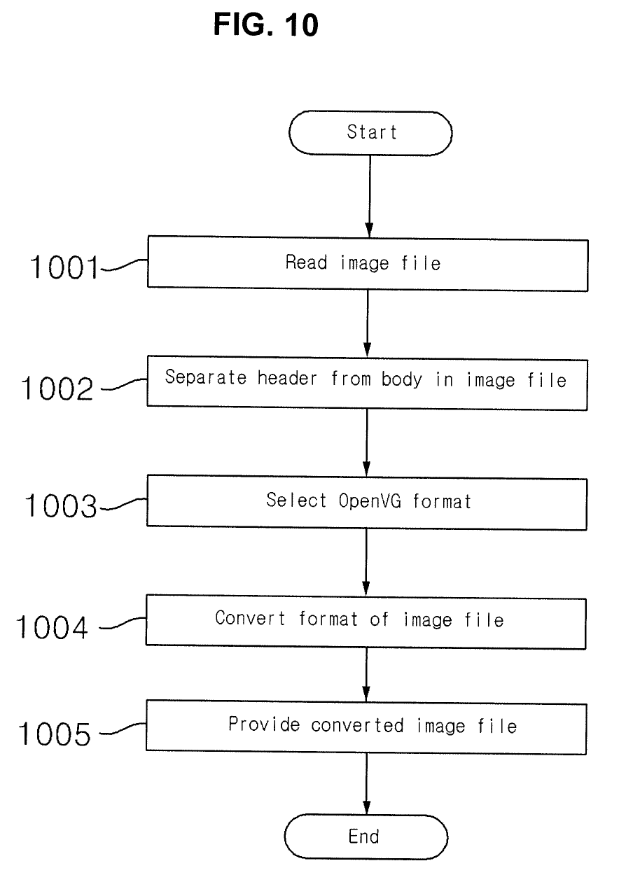

Meantime, an image previously created in a different format is converted in an OpenVG format and is provided as one of the objects of the contents, thereby enabling the reuse of image without separate image creation. A more detailed description will be later made with reference to FIG. 10.

FIG. 6 is a flowchart illustrating a method for creating an OpenVG API syntax according to an exemplary embodiment of the present invention.

As shown in FIG. 6, in Step 601, a syntax associated with an attribute or event of an object of written contents is registered and extracted. In other words, the syntax associated the attribute or event of the object selected by user is registered to a syntax memory in real time. In an OpenVG creation engine, the registered syntax is extracted and automatic creation is prepared. The syntax, which is a statement comprised in a script created to drive contents, defines each attribute or event of object of the contents. The syntax memory is a storage module for storing all syntax. The OpenVG creation engine is a module for extracting syntax from the attribute or event of the object of the written contents and creating an OpenVG API syntax.

In Step 602, an OpenVG format syntax is automatically created for each of the registered syntax.

In Step 603, the created OpenVG format syntax is checked in format. At this time, it is checked whether the OpenVG format syntax each is normal or abnormal in format. If the format is normal, next Step 604 is performed. If the format is abnormal, the Step 601 is again performed.

In the Step 604, an OpenVG API syntax format of written contents is completely created. In other words, the OpenVG format syntax created in the Steps 601 to 603 are all combined and thereby creating one OpenVG API syntax format.

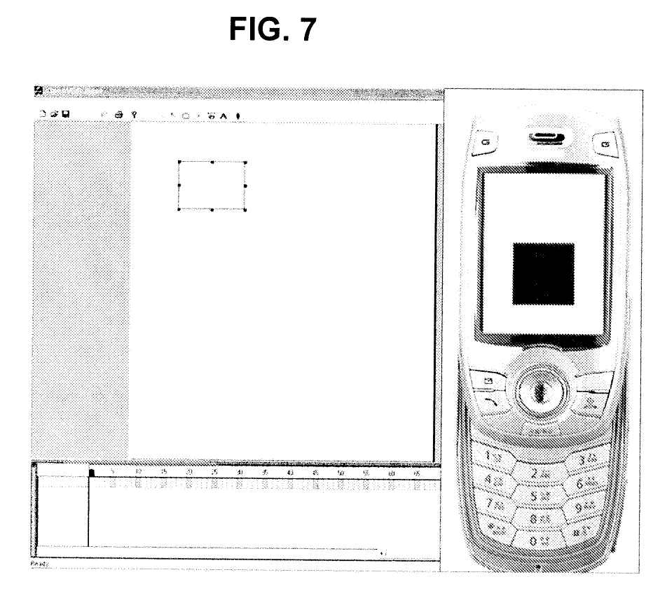

FIG. 7 illustrates a method for driving and checking syntax according to an exemplary embodiment of the present invention.

The left side of FIG. 7 is the representation of written contents and the right side is the representation of a screen on which an OpenVG API syntax created along with writing contents is driven and displayed. As described above, in an exemplary embodiment of the present invention, the user can check the created OpenVG API syntax in real time by driving and displaying the created OpenVG API syntax by a previously provided viewer module. Accordingly, the normality of the syntax can be adaptively checked and the check result can be reflected, thereby creating OpenVG contents within a short time.

Thus, in an exemplary embodiment of the present invention, the written contents are displayed on writing screens shown in FIGS. 3 to 5 and the driven syntax is displayed as in FIG. 7, thereby enabling the user to conveniently do contents writing or syntax checking as recognizing them.

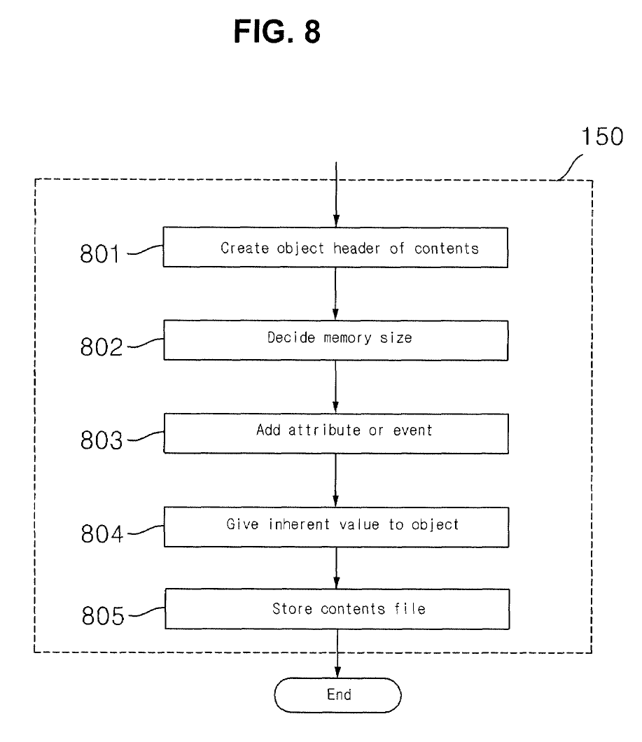

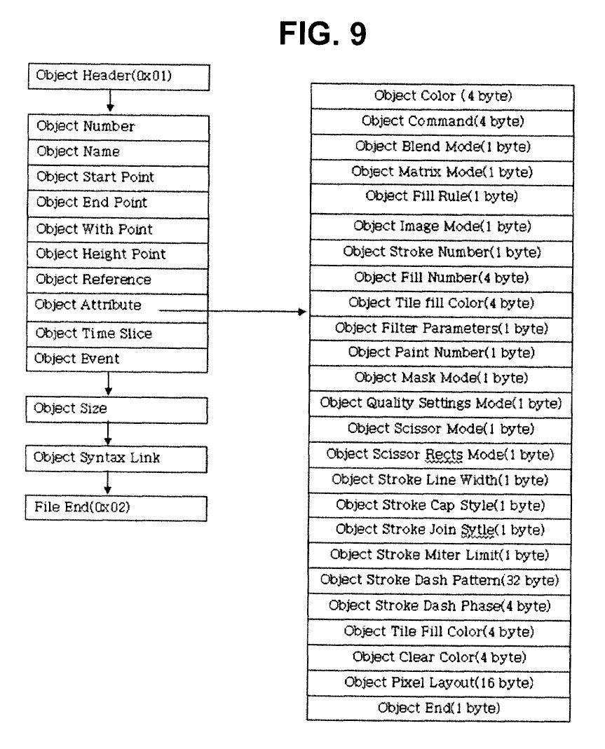

FIGS. 8 and 9 illustrate a method for storing contents according to an exemplary embodiment of the present invention. FIG. 8 is a flowchart illustrating the method for storing contents according to an exemplary embodiment of the present invention. FIG. 9 illustrates the layout of a contents file according to an exemplary embodiment of the present invention.

As shown in FIG. 8, in the method for storing contents according to an exemplary embodiment of the present invention, in Step 801, an object header of contents is created. In Step 802, a memory size for storing an object of the contents is decided. In Step 803, an attribute or event is structuralized in a file form and is added to the object of the contents. FIG. 9 illustrates an example of the layout of a contents file. According to an exemplary embodiment of the present invention, the file layout is constructed as shown in FIG. 9. In Step 804, the addition-completed object of the contents is given an inherent value. In Step 805, the object of the contents is stored as a file. The stored contents are provided to a writing environment when user again writes contents.

As above, in an exemplary embodiment of the present invention, the contents of the final OpenVG API script are reused. Alternately, the contents are objectified and stored as a file to acquire a contents copyright. Here, the contents are stored as a file as having the inherent value of the attribute or event of the object. The inherent value, which is an attribute value or event value of the object of the contents, is a specific value that each syntax has. For example, the inherent value is defined as a value of circle size, color, shape, position, etc. As described above, all specific context of the contents written by user can be stored as given the inherent value. By doing so, the contents can be restored to an original state when the contents file is opened.

FIG. 10 is a flowchart illustrating a method for converting image according to an exemplary embodiment of the present invention.

As shown in FIG. 10, in the method for converting image in format according to an exemplary embodiment of the present invention, in Step 1001, a previously created image file is read. The previously created image file is the representation of an image file made up of a file extension such as jpeg, bmp, gif, png, etc. In Step 1002, the image file is separated into a header and a body. This is the analysis of the format of the image file. In Step 1003, any one of OpenVG formats is selected depending on information inputted by the user. In Step 1004, the format of the image file is converted into the selected OpenVG format. For example, a target image file is converted and conformed to a bytes-per-pixel format. In Step 1005, the converted image file is provided as an object of contents to an environment in which contents are written.

The thus converted image file is used when an image object is selected from the objects of contents to be written as mentioned above in FIGS. 2 and 3, for example. In detail, when the user intends to read and use a previously created image having a different format, the image file is processed and provided in the Steps 1001 to 1005 and then, is used at the time of registering and editing an attribute or event. Thus, an image previously created in a different format can be converted into an OpenVG format and can be provided as one of the objects, thereby enabling the reuse of image without separate image creation.

In the method for converting image in format according to an exemplary embodiment of the present invention, it is further checked whether the converted image is suitable as an OpenVG API syntax, thereby improving a reliability on the checking whether the converted image file is normal or abnormal.

As described above, the present invention can automatically create contents served for the mobile terminal in the OpenVG format and reuse the created contents, thereby conveniently and easily writing the contents.

Also, the present invention can check the automatically created OpenVG API script by a built-in viewer, thereby creating a high-quality OpenVG format contents within a short time.

Also, the present invention can objectify the created contents by the OpenVG API script, give the inherent value to the contents, and store the contents as a file, thereby maintaining the inherent attribute of the contents and making the reuse of contents more efficient.

Also, the present invention can convert the image file in the OpenVG format, thereby reducing an effort for separate image creation, facilitating contents creation, and improving a quality of contents.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for creating Open Vector Graphic (OpenVG) contents, the method comprising:
providing an environment in which contents are written;
creating an OpenVG Application Program Interface (API) syntax associated with the written contents;
driving and checking the created OpenVG API syntax;
creating a final OpenVG API script made up of the OpenVG API syntax; and
storing contents objectified by the final OpenVG API script.

2. The method of claim 1, wherein the contents comprise mobile contents served for a mobile terminal.

3. The method of claim 1, wherein the providing of the environment comprises:
selecting an object of contents to be written, depending on information inputted by user;
displaying the selected object of the contents on a writing screen; and
registering and editing an attribute or event of the displayed object of the contents depending on information inputted by user.

4. The method of claim 1, wherein the providing of the environment comprises:
providing an image converted into an OpenVG format as an object of the contents to the environment in which the contents are written.

5. The method of claim 4, wherein the providing the converted image comprises:
reading a previously created image file;
separating a header from a body in the image file;
selecting any one of the OpenVG formats depending on information inputted by user;
converting a format of the image file into the selected OpenVG format; and
providing the converted image file to the environment in which contents are written.

6. The method of claim 5, wherein the providing the converted image further comprises:
checking whether the converted image is suitable as the OpenVG API syntax.

7. The method of claim 1, wherein the creating of the OpenVG API syntax comprises:
registering and extracting a syntax associated with an attribute or event of an object of the written contents;
creating an OpenVG format syntax for each of the registered syntax;
checking a format of the created OpenVG format syntax; and
creating an OpenVG API syntax format of the written contents.

8. The method of claim 1, the method further comprises:
displaying the written contents or the driven syntax.

9. The method of claim 1, wherein the storing objectified contents comprises:
storing an inherent value associated with an attribute or an event of an object of the contents as a file.

10. The method of claim 9, wherein the storing objectified contents further comprises:
creating a header of the object of the contents;
deciding a memory size for storing the object of the contents;
structuralizing an attribute or event in a file form and adding the attribute or event to the object of the contents;
giving the inherent value to the addition-completed object of the contents; and
storing the object of the contents as a file.

11. The method of claim 1, the method further comprises:
providing the stored contents to the environment in which contents are written.

12. A computer readable record medium storing instructions for executing a method for creating Open Vector Graphic (OpenVG) contents, the method comprising:
providing an environment in which contents are written;
creating an OpenVG Application Program Interface (API) syntax associated with the written contents;
driving and checking the created OpenVG API syntax;
creating a final OpenVG API script made up of the OpenVG API syntax; and
storing contents objectified by the final OpenVG API script.

13. The computer readable record medium of claim 12,
wherein the contents comprise mobile contents served for a mobile terminal.

14. The computer readable record medium of claim 12, wherein providing the environment comprises:
selecting an object of contents to be written, depending on information inputted by user;
displaying the selected object of the contents on a writing screen; and
registering and editing an attribute or event of the displayed object of the contents depending on information inputted by the user.

15. The computer readable record medium of claim 12, wherein providing the environment comprises:
providing an image converted into an OpenVG format as an object of the contents to the environment in which the contents are written.

16. The computer readable record medium of claim 15, wherein providing the converted image comprises:
reading a previously created image file;
separating a header from a body in the image file;
selecting any one of the OpenVG formats depending on information inputted by user;
converting a format of the image file into the selected OpenVG format; and
providing the converted image file to the environment in which contents are written.

17. The computer readable record medium of claim 12, wherein the creating of the OpenVG API syntax comprises:
registering and extracting a syntax associated with an attribute or event of an object of the written contents;
creating an OpenVG format syntax for each of the registered syntax;
checking a format of the created OpenVG format syntax; and
creating an OpenVG API syntax format of the written contents.

18. The computer readable record medium of claim 12, wherein the method further comprises
displaying the written contents or the driven syntax.

19. The computer readable record medium of claim 12, wherein the storing objectified contents comprises:
storing an inherent value associated with an attribute or an event of an object of the contents as a file.

20. The computer readable record medium of claim 12, wherein the storing objectified contents further comprises:
creating a header of the object of the contents;
deciding a memory size for storing the object of the contents;
structuralizing an attribute or event in a file form and adding the attribute or event to the object of the contents;
giving the inherent value to the addition-completed object of the contents; and
storing the object of the contents as a file.
